(19) United States
(12) Patent Application Publication
(10) Pub. No.: US 2008/0308339 A1
(43) Pub. Date: Dec. 18, 2008

(54) Fuel feeding mechanism of a vehicle

(76) Inventor: Chun-Chih Wang, Nanhua Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/808,578

(22) Filed: Jun. 12, 2007

(51) Int. Cl. B60K 20/02

(52) U.S. Cl. 180/338

(57) ABSTRACT

A fuel feeding mechanism of a vehicle includes an electronic control unit, and a throttle; the throttle is equipped with a feedback signal device, and the feedback signal device is connected to the electronic control unit; the throttle includes a pivotal shaft; a throttle position sensor is connected to the pivotal shaft of the throttle; a signal source is connected to the throttle position sensor as well as the feedback signal device of the throttle to interfere in and change a signal of the throttle, thus advancing the time of the vehicle shifting gears and helping to reduce fuel consumption.

### BACKGROUND OF THE INVENTION

1. Field of the Invention

The present invention relates to an improvement on a fuel feeding mechanism of a vehicle, more particularly one, whose throttle position sensor is equipped with a signal source to interfere in and change a signal of the throttle so as to advance the time of the vehicle shifting gears and help to reduce fuel consumption.

2. Brief Description of the Prior Art

Vehicles are among necessities of daily life, which provide people with better mobility and convenience. Most of the fuels of vehicles are extracted from petroleum. Petroleum isn't a kind of inexhaustible natural resource, and it can be dried up very soon. Furthermore, combustion of petrolic fuels will produce much air pollution. In order to deal with the above problems, many manufacturers are devoting much money and time to developing better products and manufacturing method so that less energy is consumed in manufacturing. In the light of the fact that a large proportion of gasoline is consumed with vehicles, many people decide to reduce use of cars as much as possible, and the industry are devoting much effort to developing more advanced fuel feeding mechanisms for vehicles in order for the vehicles to consume less fuel in running.

A kind of currently existing vehicle fuel-feeding mechanism includes an electronic control unit, and a throttle. The throttle comprises a pivotal shaft, and a valve pivoted on the pivotal shaft, and is equipped with a feedback signal device. The feedback signal device is connected with the electronic control unit. Furthermore, a throttle position sensor is connected with the pivotal shaft of the throttle, which sensor is equipped with a variable resistor capable of changing in resistance in rotation.

The above vehicle fuel-feeding mechanism is found to have the following drawbacks:

1. With the fuel-feeding mechanism, the engine of the vehicle will increase the rotational speed in order to speed up the vehicle in gear-shifting. Consequently, a large amount of fuel will be consumed.

2. For the above reason, many drivers decide to re-equip their car engines in order to reduce the expense on fuel. However, such a re-equip takes much money, and re-equips are usually different for the engines of vehicles of different models.

### SUMMARY OF THE INVENTION

In the light of the fact that the above vehicle fuel-feeding mechanism will consume a much greater amount of fuel in gear-shifting, and it will take much time, labor, and money to re-equip the vehicle engine, the inventor of the present invention has been devoting much time and effort to developing an improvement on a vehicle fuel-feeding mechanism, which can advance the time of the vehicle shifting gears, and help to reduce fuel consumption, and which is suitable for use with vehicles of any model without re-equipping the engine.

A fuel feeding mechanism according to an embodiment of the present invention includes an electronic control unit, and a throttle. The throttle includes a pivotal shaft and a valve pivoted on the pivotal shaft, and is connected with a feedback signal device. The feedback signal device is connected to the electronic control unit. A throttle position sensor is connected to the pivotal shaft of the throttle; the throttle position sensor includes a variable resistor, which will change in resistance on rotation, and which is connected with a signal source. The signal source is connected with the feedback signal device of the throttle so as to interfere in and change a signal of the throttle, thus advancing the time of the vehicle shifting gears and helping to reduce consumption of fuel.

### BRIEF DESCRIPTION OF THE DRAWINGS

The present invention will be better understood by referring to the accompanying drawings, wherein:

FIG. 1 is a perspective view of the present invention installed on a vehicle,

FIG. 2 is an enlarged partial perspective view of the invention,

FIG. 3 is a perspective view of the present invention,

FIG. 4 is a diagram of connection between the electronic control unit and the throttle position sensor of the present invention, and

FIG. 5 is a circuit diagram of the throttle position sensor of the present invention.

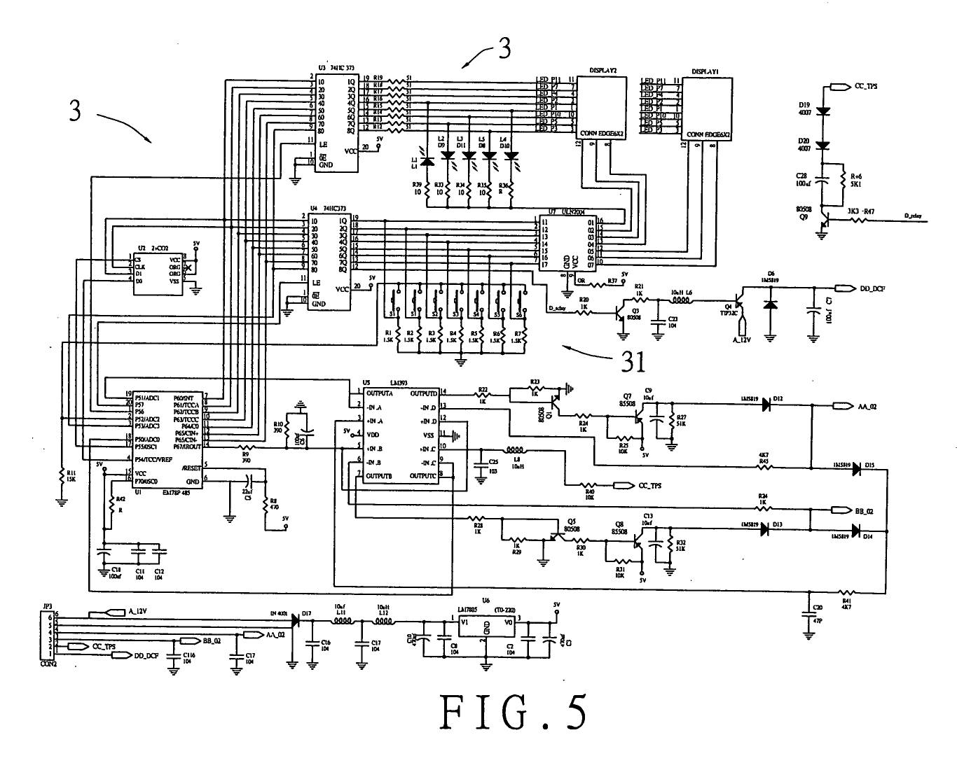

### DETAILED DESCRIPTION OF THE PREFERRED EMBODIMENTS

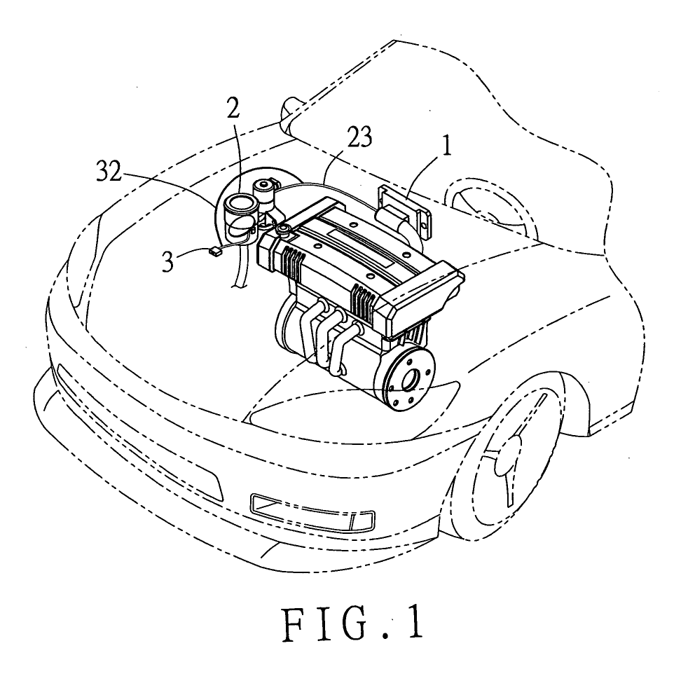

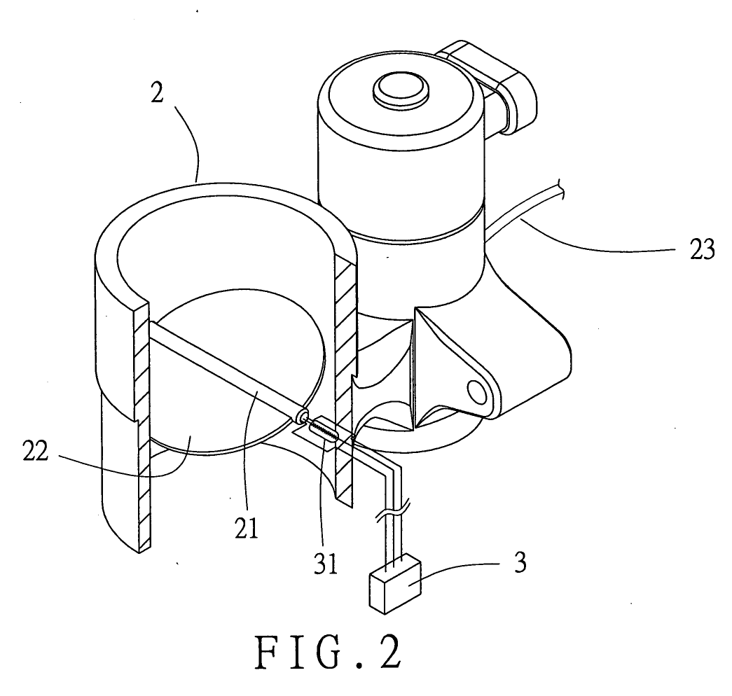

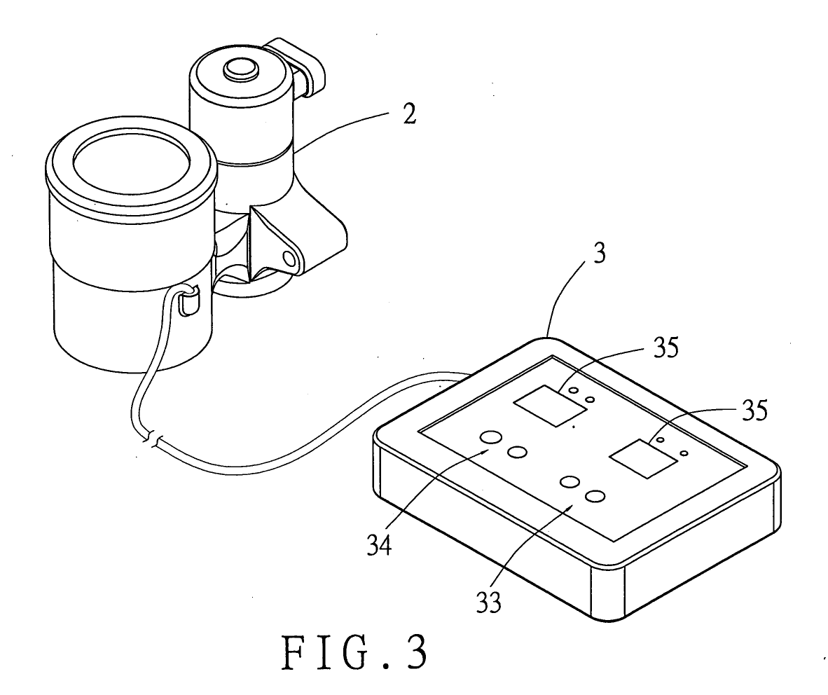

Referring to FIG. 1 to FIG. 4, a preferred embodiment of a fuel feeding mechanism of a vehicle in the present invention includes an electronic control unit (ECU) 1, a throttle 2, and a throttle position sensor (TPS) 3.

The electronic control unit 1 is used to control operation of an engine of a vehicle in order for allowing an optimum amount of fuel to be injected, and ignition to take place at an optimum time.

The throttle 2 is a valve of a butterfly-shaped type. The throttle 2 comprises a pivotal shaft 21, and a valve 22 pivoted on the pivotal shaft 21. Furthermore, the throttle 2 is connected to a feedback signal device 23.

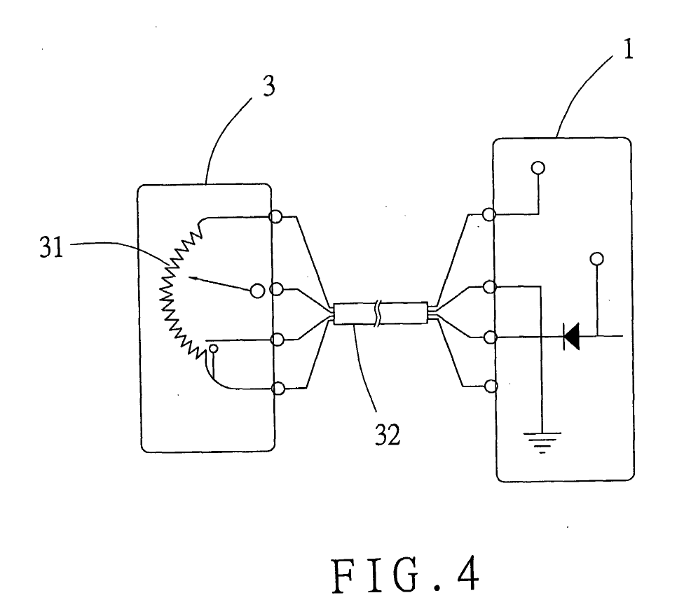

Referring to FIG. 4 as well, the throttle position sensor 3 includes a variable resistor 31, which will change in resistance when being rotated. The throttle position sensor 3 includes a signal source 32, which is connected to the variable resistor 31. The throttle position sensor 3 further includes adjustment buttons 33 for start of the throttle position sensor 3, adjustment buttons 34 for stoppage of the throttle position sensor 3, and indicating lamps 35. The adjustment buttons 33 for start are used to set a floor value of a rotational speed of the engine; the throttle position sensor 3 will be activated, and a stable voltage will be transmitted to the electronic control unit 1 as soon as the rotational speed of the engine reaches the floor value. The adjustment buttons 34 for stoppage are used to set a ceiling value of a rotational speed of the engine; the throttle position sensor 3 will be turned off, and a stable voltage will be transmitted to the electronic control unit 1 as soon as the rotational speed of the engine reaches the ceiling value. The indicating lamps 35 are used to show a current set value of rotational speed of the engine in the above setting.

In assembly, referring to FIG. 1 to FIG. 4, the feedback signal device 23 of the throttle 2 is connected to the electronic control unit 1; thus, a signal of the valve 22 opening is feedback to the electronic control unit 1 in order for the electronic control unit 1 to make the engine to run on an optimum amount of fuel injection. The variable resistor 31 of the throttle position sensor 3 is installed on the pivotal shaft 21 of the throttle 2 so as to change in its resistance in rotational motion of the pivotal shaft 21. The signal source 32 of the throttle position sensor 3 is connected to feedback signal device 23 of the throttle 2; the signal source 32 is used to transmit a signal to the electronic control unit 1, which is slightly smaller than the signal feedback from the throttle 2 to the electronic control unit 1, so as to interfere in and change the signal of the throttle 2; thus, the time of the vehicle shifting gears is advanced. For example, the rotational speed of the vehicle engine is 2500 RPM/60 KM originally, and will become 2200 RPM/60 KM after the signal is changed.

To put the fuel feeding mechanism of the present invention to use, referring to FIG. 1 to FIG. 4, the driver uses the adjustment buttons 33 to set a floor value of rotational speed of the engine, and uses the adjustment buttons 34 to set a ceiling value of rotational speed of the engine according to the model and the exhaust amount of the vehicle. Therefore, in the course of the vehicle shifting gears, the rotational speed of the engine will be in the range of the floor value to the ceiling value. And, the throttle position sensor 3 will transmit a stable voltage feedback to the electronic control unit 1, and in turn the electronic control unit 1 will control the fuel injector so as not to inject additional fuel in gear-shifting of the vehicle, thus helping to save fuel; conventionally, engines will consume more fuel in gear-shifting of vehicles.

From the above description, it can be seen that the fuel feeding mechanism of the present invention has the following advantages over the prior art:

1. The throttle position sensor of the present invention includes a variable resistor, and a signal source, which is connected to the variable resistor as well as the feedback signal device of the throttle so as to interfere in and change the signal of the throttle in order to advance the time of the vehicle shifting gears, thus helping to reduce consumption of fuel.

2. The fuel feeding mechanism is suitable for use with vehicles of any model to save fuel. And, it is more economical to use the fuel feeding mechanism than it is to re-equip the vehicle engine. Therefore, the present invention is very practical.

1. An improvement on a fuel feeding mechanism of a vehicle, comprising
an electronic control unit,
a throttle, the throttle including a pivotal shaft, and a valve pivoted on the pivotal shaft; the throttle including a feedback signal device, which is connected to the electronic control unit; and
a throttle position sensor connected to the pivotal shaft of the throttle;
and characterized by:
the throttle position sensor being connected to a signal source; and the signal source being connected to the electronic control unit.

2. The improvement on a fuel feeding mechanism of a vehicle as recited in claim 1, wherein the throttle position sensor is equipped with a variable resistor.

3. The improvement on a fuel feeding mechanism of a vehicle as recited in claim 1, wherein the signal source of the throttle position sensor is connected to the feedback signal device of the throttle.

4. The improvement on a fuel feeding mechanism of a vehicle as recited in claim 1, wherein the throttle position sensor has a plurality of adjustment buttons for start, a plurality of adjustment buttons for stoppage, and a plurality of indicating lamps, which are used to set values of rotational speed of an engine.
